(19) United States
(12) Patent Application Publication
(10) Pub. No.: US 2004/0060458 A1
(43) Pub. Date: Apr. 1, 2004

(54) Method for heat treatment and preservation under controlled gas pressure

(76) Inventor: Vanda Janka, Neyruz (CH)

Correspondence Address: Oliff & Berridge PLC, Po Box 19928, Alexandria, VA, 22320, US

(21) Appl. No.: 10/467,822

(22) PCT Filed: Feb. 15, 2002
(86) PCT No.: PCT/CH02/00097

(51) Int. Cl. A23B 4/00

(52) U.S. Cl. 99/470; 426/523

(57) ABSTRACT

Process for treating the substances (5),

after having placed these substances in the receptacle (1), then closed this receptacle (1), the contents of said receptacle (1) are heated up to a first temperature value (T1), so as to cause the treatment sought,

at the time of the cooling of the contents of the receptacle (1) toward a second predetermined temperature value (T2), such as the ambient temperature, before the temperature of the contents of the receptacle (1) reaches this second predetermined temperature value (T2), a gaseous fluid (8) developing a pressure within the receptacle (1) is allowed to escape through at least one orifice (7) of a given cross-section, contrived beforehand in the wall of said receptacle (1), this escape of gaseous fluid (8) taking place until the temperature of the substances (5) contained in this receptacle (1) reaches a third predetermined temperature value (T3), and that at this third predetermined temperature value (T3), the escape orifice (7) is fluid-tightly stopped by means of a stopping element (9),

this process being characterized in that with a view to, simultaneously,

controlling the deformation of the flexible wall of said receptacle (1) at the time of cooling and after the stopping operation and,

guaranteeing the preservation of the substances contained in said receptacle (1),

the third temperature value (T3), on the one hand, and the value of the cross-section of the escape orifice (7), on the other hand, are chosen in such a way that this escape orifice (7) can be stopped when:

the temperature (Tg) of the gaseous fluid (8) contained in the receptacle (1) has reached a previously determined value relative to a nominal value considered to be the lower limit for guaranteeing the neutrality of the atmosphere contained in said receptacle (1), and

the value of the pressure (Pi) of this gaseous fluid

(8) within the receptacle (1) is greater than the value of the external gas pressure Pe and reflects the presence within said receptacle (1) of a volume of gaseous fluid (8) at least sufficient so that, after stopping of said escape orifice (7) and cooling of the contents of the receptacle (1) to the second temperature value (T2), said gaseous fluid (8) develops its pressure against the wall (11) of the receptacle (1) and opposes a detrimental deformation of this wall (11) under the influence of the pressure (Pe) outside the receptacle (1), this deformation being considered detrimental when at least one of the visual aspects, which are the visual aspect of the receptacle (1) and that of its contents, is altered.

The invention relates to a process for heat treatment of substances placed in flexible-walled receptacles.

The invention applies more particularly, but not exclusively, to the heat treatment of substances placed in flexible-walled receptacles with a view to their preservation in these receptacles.

The invention applies advantageously, but not exclusively, to the heat treatment of substances consisting of perishable commodities, especially of perishable foodstuffs.

Designated as perishable foodstuffs are, by way of example, meat, fish, vegetables, prepared dishes . . .

The invention likewise relates:

to an installation designed for carrying out the process,

to a receptacle designed for carrying out the process,

to a stopping element designed for carrying out the process,

to the substances placed in flexible-walled receptacles and treated according to said process.

Designated as a flexible-walled receptacle is a receptacle made up of at least one element, the wall of which is at least locally flexible, i.e., has a resistance to bending such that this wall is capable of being deformed notably under the influence of a dominant gas pressure developed by a fluid situated:

inside said receptacle, especially when an increase in the internal temperature of the contents of the receptacle brings about the expansion of a gaseous fluid situated in said receptacle, and/or

outside said receptacle, especially when a reduction of the internal temperature of the contents of the receptacle brings about the condensation of a fluid in gaseous state situated in said receptacle.

In the field of the preservation of foodstuffs, it has long been known to treat the foods thermally at a high temperature, and especially to cook them, in a receptacle, the wall of which will subsequently constitute a barrier to the air and to the germs it contains.

In this field, it is known:

to make up receptacles of a sheet of flexible and transparent synthetic material, advantageously weldable to itself, then

to place the substances therein,

to close each receptacle after having extracted the air therefrom,

to raise the temperature, for example, to produce pasteurization, sterilization, or cooking.

These receptacles may have different shapes, for example, consist of a pocket, the loading aperture of which is closed by bringing together and welding parts of the edge which define it, or a tub comprising an opening equipped with a peripheral surface against which a lid is welded.

With this type of receptacle, the substances to be heat-treated must, prior to the step of heat treatment, be closed in each receptacle under vacuum.

The function of this step is notably to reduce the influence of the air remaining in the receptacle and which, by dilating at the time of the heat treatment, would be liable to induce the bursting of said receptacle.

The major drawback of this type of packaging is that at the end of the vacuum-packing step, the substances are greatly compressed against each other and against the walls of the receptacle in which they are contained, which may considerably change their appearance, even destroy them.

Without remedying the crushing of the substances thus treated for all that, it is known to mask the compressed appearance of said substances by covering the receptacle at least partially with an opaque material, such as a cardboard outer packaging.

This solution substantially increases the selling price of the treated products.

Another costly solution consists in utilizing an oven of the so-called counter-pressure type to combat the deformation of the wall of the receptacle during the heat treatment.

Another solution consists in equipping the receptacle with an automatic valve which is to permit the escape of the gaseous fluid contained in this receptacle until at least one of the parameters, either the internal temperature or the internal pressure, reaches a predetermined value.

When the predetermined value is reached, the valve closes and prevents any passage.

Such automatic valves have their advantages, but besides being costly to perfect, they do not guarantee controlling of the deformation of the flexible wall of said receptacle at the time of cooling.

For with these valves, when closing is confirmed, the underpressure in the receptacle generally reaches a certain vacuum level, even a vacuum level which may be called a total vacuum, which more or less notably affects the shape of the wall of said receptacle.

One result which the invention aims at obtaining is a process which, while being simple and economical to carry out, allows substances placed in flexible-walled receptacles to be heat-treated without bringing about the drawbacks just recounted.

Another result which the invention aims at obtaining is a process which permits controlling the quantity and the quality of the gaseous fluid contained in the receptacle before closing the escape orifice of this receptacle and after closing of this orifice.

To this end, the subject of the invention is a process for the heat treatment of substances contained in a flexible-walled receptacle, i.e., made up of at least one walled element at least locally flexible, and according to which process, for treating the substances,

after having placed said substances in the receptacle, then closed this receptacle, the contents of said receptacle are heated up to a first temperature value so as to cause the desired thermal treatment,

at the time of the cooling of the contents of the receptacle toward a second predetermined temperature value, such as the ambient temperature, before the temperature of the contents of the receptacle reaches this second predetermined temperature value, a gaseous fluid developing a pressure within the receptacle is allowed to escape through at least one orifice of given cross-section, contrived beforehand in the wall of said receptacle, this escape of gaseous fluid taking place until the temperature of the substances contained in this receptacle reaches a third predetermined temperature value, and that at this third predetermined temperature value, the escape orifice is fluid-tightly stopped by means of a stopping element.

This process is characterized in that, with a view to simultaneously

controlling the deformation of the flexible wall of said receptacle at the time of cooling and after the stopping operation, and

guaranteeing the preservation of the substances placed in this receptacle,

the third temperature value, on the one hand, and the value of the cross-section of the escape orifice, on the other hand, are chosen in such a way that this escape orifice can be stopped when:

the temperature of the gaseous fluid contained in the receptacle has reached a previously determined value relative to a reference value considered to be the lower limit for guaranteeing the neutrality of the atmosphere contained in said receptacle, and

the value of the pressure of this gaseous fluid within the receptacle is greater than the value of the external gaseous pressure and reflects the presence within said receptacle of a volume of gaseous fluid at least sufficient so that, after stopping of said escape orifice and cooling of the contents of the receptacle to the second temperature value, said gaseous fluid develops its pressure against the wall of the receptacle and opposes a prejudicial deformation of this wall under the influence of the pressure outside the receptacle, this deformation being considered prejudicial when at least one of the visual aspects, being the visual aspect of the receptacle and that of its contents, is altered.

By way of example, the visual aspect of a receptacle having a given geometrical shape before treatment is considered to be altered after treatment when this receptacle presents:

one or more edges, the straightness of which is no longer respected, or

one or more faces with creases or a notable concavity.

The invention likewise relates:

to an installation designed for carrying out the process,

to a receptacle designed for carrying out the process,

to a stopping element designed for carrying out the process,

to the substances placed in flexible-walled receptacles and treated according to said process.

The invention will be well understood upon reading the following description made by way of non-limiting example, in comparison with the enclosed drawing, which shows:

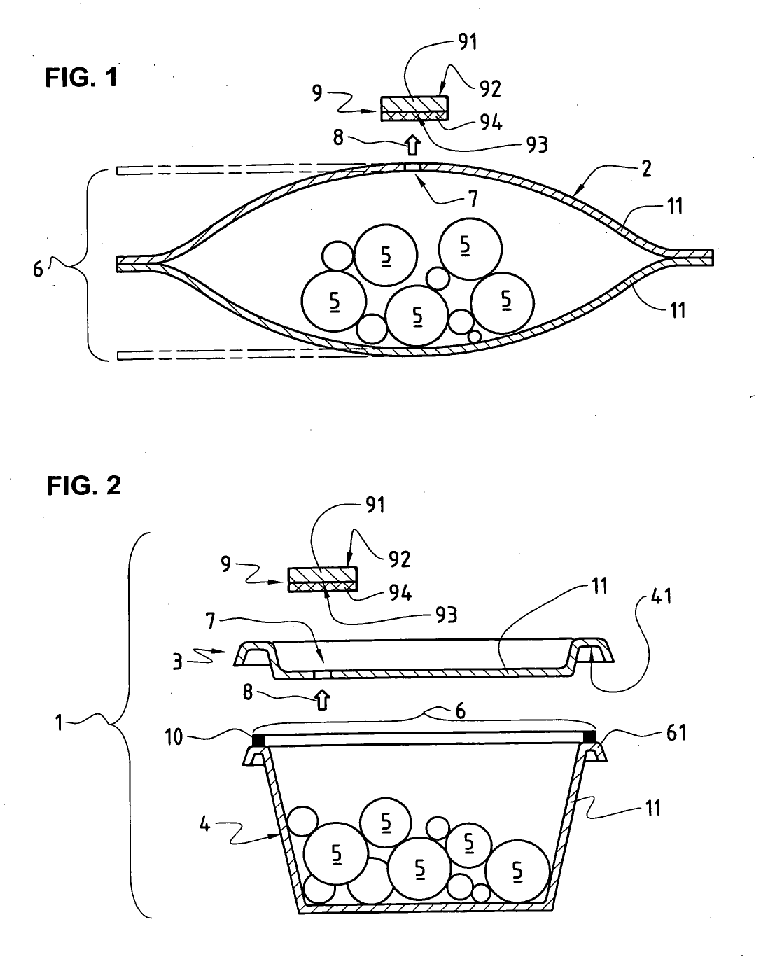

FIGS. 1 and 2: seen in cross-section, receptacles for the heat treatment of substances, according to the process of the invention.

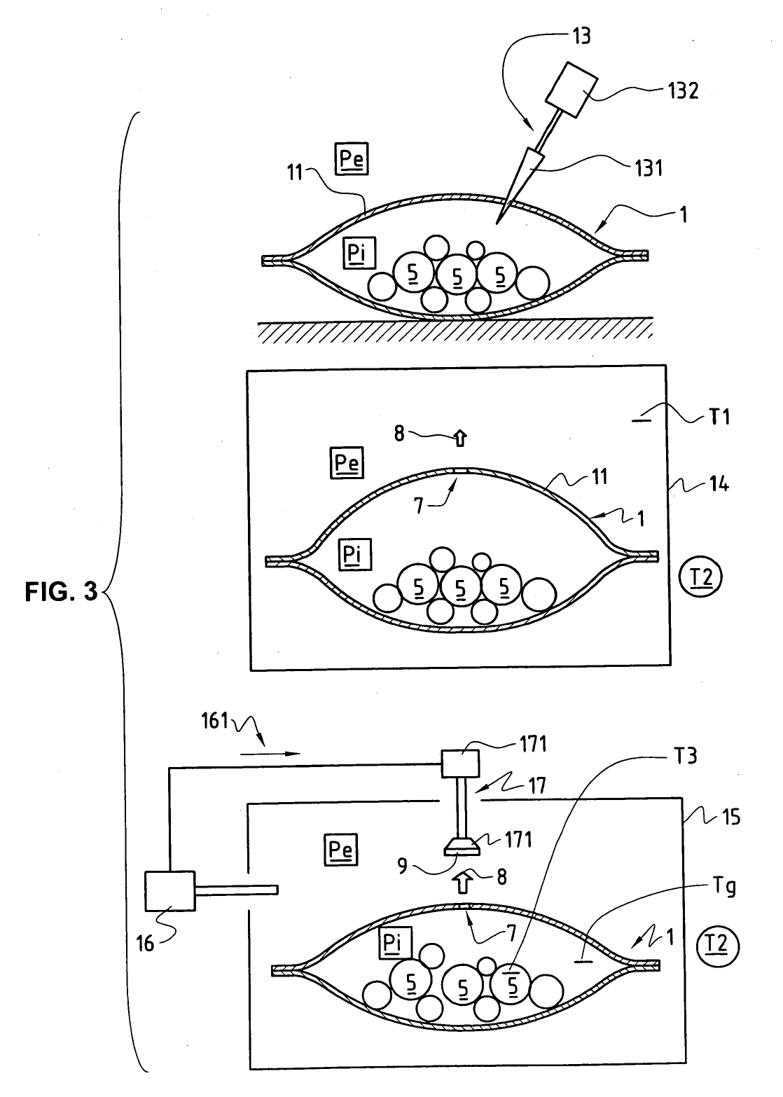

FIG. 3: an installation intended for carrying out the process according to the invention.

Referring to the drawing, a receptacle 1 with a flexible wall 11 is seen, i.e., a receptacle 1 made up of at least one element 2, 3, 4 with a flexible wall 11, intended to contain substances 5 for their preservation after heat treatment.

Although this does not appear in the drawings, designated as receptacle 1 with a flexible wall 11 is a receptacle 1 made up of at least one element 2, 3, 4, the wall 11 of which is at least locally flexible, i.e., has a resistance to bending such that this wall 11 is capable of being deformed notably under the influence of a gas pressure developed by a fluid situated within said receptacle 1, especially at the time of a rise in pressure brought about by an increase in the temperature of the contents of said receptacle 1.

In the drawings, the gas pressure inside the receptacle 1 is symbolized by a square marked Pi, while the gas pressure outside said receptacle is symbolized by a square which, situated outside said receptacle, is marked Pe.

To carry out the heat treatment of substances 5 with a view to their preservation under controlled gas pressure:

one provides oneself with a receptacle 1 with a flexible wall 11 and including a loading aperture 6,

the substances 5 are introduced into this receptacle 1,

the receptacle 1 is closed,

at least the contents of the receptacle 1 are heated up to a first predetermined temperature value T1 so as to cause the heat treatment sought, for example, pasteurization, cooking, or sterilization of the substances 5,

said receptacle 1 and its contents are allowed to cool down, especially to a second predetermined temperature value T2, such as the ambient temperature, or a storage temperature.

During this treatment, care must be taken to:

make in the wall 11 of the receptacle 1, prior to the heat treatment at the latest, at least one orifice 7, called escape orifice 7, of a cross-section notably reduced compared with the cross-section of the aperture 6 of said receptacle 1 but which is able to constitute a passage for a gaseous fluid 8 developing its pressure within the receptacle 1,

carry out the heat treatment of the substances 5 contained in the receptacle 1 by bringing them to the first predetermined temperature T1, and doing so without hindering the possibility for the gaseous fluid 8 contained in the receptacle 1 to escape through the escape orifice 7 provided for that purpose, then,

lower the temperature of the substances 5 contained in the receptacle 1 down to a third predetermined temperature value T3, and doing so without hindering the possibility for the gaseous fluid. 8 contained in the receptacle 1 to escape through the escape orifice 7 provided for that purpose, and,

when the third predetermined temperature value T3 is reached, to fluid-tightly stop the escape orifice 7 made in the wall 11 of said receptacle 1, and doing so by means of a stopping element 9.

During the treatment, care is taken, at the same time:

to preserve the neutrality of the atmosphere finally kept in the receptacle 1, i.e., the gaseous atmosphere contained in said receptacle 1 after the stopping operation,

to limit the deformation of the flexible wall of said receptacle 1 at the time of cooling, especially toward said predetermined second temperature value T2.

More synthetically, it may be remembered that the invention concerns a process for the heat treatment of substances 5 contained in a receptacle 1 with a flexible wall 11, i.e., made up of at least one element 2, 3, 4 with a wall 11 at least locally flexible, and according to which process, for treating the substances 5,

after having placed said substances 5 in the receptacle 1, then closed this receptacle 1, the contents of said receptacle 1 are heated up to a first temperature value T1 so as to cause the desired treatment,

at the time of the cooling of the contents of the receptacle 1 toward a second predetermined temperature value T2, such as the ambient temperature, before the temperature of the contents of the receptacle reaches this second predetermined temperature value T2, a gaseous fluid 8 developing a pressure within the receptacle 1 is allowed to escape through at least one escape orifice 7 of given cross-section, contrived beforehand in the wall of said receptacle 1, this escape of gaseous fluid 8 taking place until the temperature of the substances 5 contained in this receptacle 1 reaches a third predetermined temperature value T3, and that at this third predetermined temperature value T3, the escape orifice 7 is fluid-tightly stopped by means of a stopping element 9.

The process according to the invention is remarkable in that, with a view to simultaneously

controlling the deformation of the flexible wall of said receptacle 1 at the time of cooling and after the stopping operation, and

guaranteeing the preservation of the substances placed in this receptacle 1,

the third temperature value T3, on the one hand, and the value of the cross-section of the escape orifice 7, on the other hand, are chosen in such a way that this escape orifice 7 can be stopped when:

the temperature Tg of the gaseous fluid 8 contained in the receptacle 1 has reached a previously determined value relative to a reference value considered as the lower limit for guaranteeing the neutrality of the atmosphere contained in said receptacle 1, and

the value of the pressure Pi of this gaseous fluid 8 within the receptacle 1 is greater than the value of the external gas pressure Pe and reflects the presence within said receptacle 1 of a volume of gaseous fluid 8 at least sufficient so that, after stopping of said escape orifice 7 and cooling of the contents of the receptacle 1 to the second temperature value T2, said gaseous fluid 8 develops its pressure against the wall 11 of the receptacle 1 and opposes a prejudicial deformation of this wall 11 under the influence of the pressure Pe outside the receptacle 1, this deformation being considered prejudicial when at least one of the visual aspects, being the visual aspect of the receptacle 1 and that of its contents, is altered.

Respecting these characteristics permits the result announced for the invention to be obtained.

The gaseous fluid 8 has been symbolized by an arrow marked 8.

In general, before the thermal treatment, the gaseous fluid 8 is made up of ambient atmospheric air, such as the air which surrounds the receptacle at the moment of loading the substances, but it might be a gaseous fluid of some other nature.

During and at the end of the treatment, the gaseous fluid 8 may include air, water vapor, as well as other gases emitted by the substances at the time of the treatment.

The volume of the gases and/or vapors, essentially of the water vapor, on the one hand, produced by the substances at the time of the thermal treatment, and on the other hand, dilated by the temperature, is generally considerable and mixes with and/or is more or less substituted for the atmospheric gaseous fluid, such as atmospheric air, initially contained in the receptacle.

This is why it is considered to be more after than at the time of the thermal treatment that the substances produce or generate the gaseous fluid 8.

After treatment, the receptacles stopped according to the process of the invention therefore contain a certain volume of actually gaseous fluid, of which:

the neutrality is such that it does not affect the treated substances, and

the pressure is such that it opposes the crushing of the substances by the wall of the receptacle, under the influence of the atmospheric pressure.

Notably:

at the time of a test phase in a treatment installation of predefined type, there are determined,

on the one hand, said third temperature value T3 adapted to carry out the stopping of the escape orifice 7 of a receptacle 1 of a certain type in which certain substances 5 have been placed with a view to their treatment at the first temperature value T1, and

on the other hand, the duration of cooling necessary for the temperature of said substances 5 to reach the desired third temperature value T3,

at the time of carrying out the process for treating the same substances 5 as those considered during the test phase, and doing so in a treatment installation similar to the installation used for the test phase, in a receptacle 1 of the same type as that used at the time of this test phase, the stopping of the escape orifice 7 is carried out when the duration of cooling since the first temperature value reaches the duration determined during the test phase.

The indication according to which, to execute the treatment, an installation similar to that used for the test phase is used, does not exclude that these installations constitute, in fact, but one and the same installation.

Always according to the process, to guarantee that at the moment possible for carrying out the stopping, the value of the pressure Pi of this gaseous fluid 8 is greater than the value Pe of the gas pressure outside the receptacle 1, one proceeds in at least one of the five ways which are:

a first way according to which, during cooling, before stopping of the escape orifice 7, the evacuation of the gaseous fluid 8 is allowed to take place through the escape orifice 7 under the combined influence, on the one hand, of the natural production of this gaseous fluid 8, and on the other hand, of a thrust which is generated on this fluid 8 by the wall of the receptacle 1 to which this gaseous fluid 8 has imparted an elastic deformation beforehand,

a second way according to which, during cooling before stopping of the escape orifice 7, a thrust action is applied to the wall 11 of the receptacle 1 so as, on the one hand, to cause the gradual evacuation of said gaseous fluid 8 and to maintain a certain overpressure within said receptacle 1, and on the other hand, to affect the shape of this receptacle 1 to an extent which can be compensated for by a rise in the pressure of the gaseous fluid 8 which is produced after stopping of the escape orifice 7,

a third way in which, during cooling, before stopping of the escape orifice 7, a so-called additional gaseous fluid having predetermined characteristics is injected into the receptacle 1, and doing so with a flow and a pressure such that, when escaping through the escape orifice 7, it maintains within the receptacle 1 a pressure of gaseous fluid 8 at a value Pi greater than the value Pe of the gas pressure outside the receptacle 1 until the moment deemed possible for carrying out the stopping,

a fourth way in which, during cooling, before stopping of the escape orifice 7, a thrust action is applied to the wall 11 of the receptacle 1 in order, by maintaining a certain overpressure within said receptacle 1, to accelerate the evacuation of said gaseous fluid 8 until the escape orifice 7 is stopped,

a fifth way according to which, during cooling, before stopping of the escape orifice 7, a volume of gaseous fluid 8 is retained within the receptacle 1 at least sufficient so that, after stopping of the escape orifice 7, said gaseous fluid 8 opposes the application of this wall 11 against the substances 5 under the influence of the pressure outside the receptacle 1.

The choice of one of these ways of proceeding permits adaptation, especially, to the texture of the substances, to the volume, as well as to different types of reaction of the substances treated.

Notably:

to choose the third temperature value T3, a preliminary heat-treatment test is carried out, and when, by this preliminary test, it is found that in cooling the receptacle 1 and its contents to the second temperature value T2, the substances 5 contained in this receptacle 1 generate a volume of gaseous fluid 8 which, although causing an overpressure within the receptacle 1, does not elastically deform the wall 11 of this receptacle 1 beyond a predetermined acceptable limit,

the third temperature value T3 is set in such a way that during cooling, the escape orifice 7 is stopped no later than when the temperature Tg of the gaseous fluid 8 contained in the receptacle 1 reaches approximately the nominal value.

This first way of proceeding is particularly adapted when the volume of gaseous fluid 8 generated by the substances 5 contained in this receptacle 1 is practically evacuated before the temperature Tg of the gaseous fluid 8 contained in the receptacle reaches approximately the nominal value.

In conformity with another way of proceeding:

to choose the third temperature value T3, a preliminary heat-treatment test is made, and when it is found by this preliminary test that in cooling the receptacle 1 and its contents to the second temperature value T2, the substances 5 contained in the receptacle 1 generate a volume of gaseous fluid 8 which becomes capable of affecting the shape of the receptacle 1 essentially only when the temperature Tg of said gaseous fluid 8 contained in receptacle 1 reaches a value noticeably below the nominal value,

the third temperature value T3 is set in such a way that during cooling, the escape orifice 7 is stopped when the temperature Tg of the gaseous fluid 8 reaches a value less than the nominal value, and

during cooling, before stopping of the escape orifice, a thrust action is applied to the wall 11 of the receptacle 1 so as, on the one hand, to cause the gradual evacuation of said gaseous fluid 8 and to maintain a certain overpressure within said receptacle 1, and on the other hand, to affect the shape of this receptacle 1 to an extent which can be compensated for by a rise in the pressure of the gaseous fluid 8 which is produced after stopping of the escape orifice 7.

This deformation of the wall of the receptacle prior to stopping and to an extent which does not alter its appearance, for example by giving it locally a certain concavity, makes it possible to maintain a certain overpressure in this receptacle before stopping and to take into account the fact that a certain volume of gaseous fluid will be produced by the substances after stopping of the escape orifice.

Thus, instead of acting to alter the shape of the receptacle, the volume of fluid produced after stopping will, on the contrary, permit the receptacle to regain a shape deemed suitable.

This second way of proceeding is specially suited to the case where the substances contained in the receptacle include a central portion and a peripheral portion having different thermal inertias and, particularly, a peripheral portion which rapidly transmits its calories to the gaseous fluid contained in the receptacle and a central portion which keeps its calories for a certain length of time and does not start to transmit them to the peripheral portion until the temperature of the gaseous fluid is notably less than the nominal value.

Notably, when it is desired to stop the escape orifice 7 when the temperature Tg of the gaseous fluid 8 contained in the receptacle reaches a value below the nominal value, and when at the time of a preliminary heat-treatment test it is found that in cooling the receptacle 1 and its contents to the second temperature value T2, the substances 5 contained in this receptacle 1 do not generate a sufficient volume of gaseous fluid 8 to keep the value of the pressure Pi of this gaseous fluid 8 notably greater than the value Pe of the pressure outside the receptacle 1 until the moment of stopping:

during cooling, a so-called additional gaseous fluid having predetermined characteristics is injected into the receptacle, and doing so with a flow and a pressure such that, when escaping through the escape orifice 7, it maintains within the receptacle 1 a pressure of gaseous fluid 8 at a value Pi greater than the value Pe of the gas pressure outside the receptacle 1 at the moment deemed possible for carrying out the stopping.

This third way of proceeding is particularly adapted to the case where it is desired to stop the escape orifice 7 when the temperature of said fluid is below the nominal value, and where at this temperature, the substances contained in the receptacle no longer produce enough gaseous fluid to keep the receptacle at overpressure.

The injection of additional fluid into the receptacle allows an internal pressure sufficient to hinder the entrance of germs to be maintained.

In another notable manner, when it is desired to stop the escape orifice 7 when the temperature Tg of the gaseous fluid 8 contained in the receptacle reaches a value at least equal to the nominal value, and when, at the time of a preliminary heat-treatment test, it is found that in cooling the receptacle 1 and its contents to the second temperature value T2, the substances 5 contained in this receptacle 1 generate a volume of gaseous fluid 8 such that the value of the pressure Pi of the gaseous fluid 8 becomes notably greater than the value Pe of the pressure outside the receptacle 1 and, at least at the moment of stopping, exceeds a predetermined limit value considered to be unacceptable:

during cooling, a thrust action is applied to the wall 11 of the receptacle 1 in order, by maintaining a certain overpressure within said receptacle 1, to accelerate the evacuation of said gaseous fluid 8 until the escape orifice 7 is stopped.

This fourth way of proceeding is particularly adapted when the substances contained in the receptacle produce a large volume of gaseous fluid and when this fluid should be driven out in order, while respecting the temperature value chosen for stopping, to be able to control the deformation of the wall of the receptacle without having to increase the cross-section of the escape orifice or orifices 7, which might prove detrimental to the neutrality of the atmosphere contained in said receptacle.

According to another way of proceeding:

in order to choose the third temperature value T3, a preliminary heat-treatment test is carried out, and when, by this preliminary test, it is found that in cooling the receptacle 1 and its contents to the second temperature value T2, the wall 11 of this receptacle 1 has a tendency to lie too closely against the substances 5 at the risk of altering them, and that the presence of a predetermined gas volume would be necessary to oppose the application of the wall 11 against the substances 5 after closing of the escape orifice 7, the third temperature value T3 is set in such a way that during cooling, the escape orifice 7 is stopped when the temperature Tg of the gaseous fluid 8 reaches a value greater than the nominal value, and does this so as to retain a predetermined value of gaseous fluid 8 within the receptacle 1 such that after stopping of the escape orifice 7, said gaseous fluid 8 opposes the application of this wall 11 against the substances 5 under the influence of the pressure outside the receptacle 1.

This fifth way of proceeding is particularly adapted to the case where the substances contained in the receptacle occupy it almost totally.

The gaseous fluid retained in the receptacle opposes the application of this wall 11 against the substances 5 under the influence of the pressure outside the receptacle 1 and thereby permits ensuring them a notable protection against bruises.

By following the aforementioned indications, one skilled in the art is able to determine the first and third temperature values T1, T3 exactly, especially according to the nature of the substances 5 to be treated and to the result he seeks to obtain with the heat treatment, such as pasteurization, cooling, or and sterilization.

Notably, the nominal value considered as the lower limit to guarantee the neutrality of the atmosphere contained in said receptacle 1 is 72ø C. (seventy-two degrees Celsius).

According to a first remarkable possibility, the so-called additional gaseous fluid, having predetermined characteristics, is made up of bacteriologically neutral air.

According to a second remarkable possibility, the so-called additional gaseous fluid, having predetermined characteristics, is made up of a bacteriologically neutral, non-oxidizing gaseous fluid.

In conformity with a third remarkable possibility, the so-called additional gaseous fluid, having predetermined characteristics, is made up of gaseous fluid coming from the receptacle.

The fact that the flexible wall includes an escape orifice 7 permits avoiding its bursting at the time of the heat treatment, and the fact that the temperature and the pressure at which this escape orifice 7 is stopped after the treatment has been carried out are distinctly controlled permits guaranteeing the neutrality of the gaseous atmosphere finally imprisoned in the receptacle 1 by controlling the deformation of this wall.

By proceeding in this way, the result announced for the invention is obtained, viz., that substances 5 are obtained which, after having been heat treated in a closed receptacle 1 having a flexible wall, are not crushed or deformed by the action finally developed by the atmospheric pressure on the wall 11 of said receptacle 1.

Remarkably, the process of the invention is used for the preservation of substances 5 consisting of perishable commodities.

Further remarkably, the process of the invention is used for the preservation of substances 5 consisting of perishable foodstuffs.

Carrying out the process of the invention permits, economically, to prolong the duration of preservation of perishable foodstuffs, compared with conventional techniques, and does so without the use of preservatives.

It is estimated that the process induces a reduction of the oxygen content and an increase in the carbon dioxide content.

This modification of the residual atmosphere, i.e., of the atmosphere made up by the gaseous fluid 8 retained in the receptacle 1, suffices to cause an at least partial inhibition of the aerobic germs and of the micro-organisms which, upon contact with an atmosphere not treated according to the process, would bring about a phenomenon of putrefaction and/or the development of bruises.

It is for this reason that the process of the invention permits notably delaying the deadline for consumption of the treated products.

As concerns the sizes and shapes of escape orifice 7, they may be determined by one skilled in the art by carrying out tests.

Indeed, especially as concerns the sizes of the escape orifice or orifices 7, they may be determined according to the volume of gas to be evacuated at the time of the heat treatment.

Preferably, each escape orifice 7 is substantially circular.

Escape orifices 7 of a diameter between one and two millimeters permit obtaining good results.

Several escape orifices 7 may be made side by side and at a short distance from one another.

The escape orifices 7 may be made by any technique adapted to the material constituting the wall 11 of the receptacle 1.

For example, the escape orifices 7 may be made by stamping or punching.

Be that as it may, remarkably, for stopping the escape orifice 7, a stopping element 9 is employed, consisting of a disc 91 of flexible, air-tight material, one of the faces 92, 93 of which is joined fluid-tightly to the surface of the wall 11 which includes of escape orifice 7, so as to close this escape orifice 7 and hinder the passage of fluid through the latter.

Further remarkably, a stopping element 9 consisting of a disk 91 of flexible, air-tight material is employed.

Preferably, a stopping element 9 is employed consisting of a disc 91 of flexible, air-tight material, one 92 of the faces 92, 93 of which is coated with a layer 94 of glue chosen for producing the fluid-tight connection to the wall 11 of the receptacle.

It is understood, therefore, that the process of the invention is extremely simple to carry out, whether manually or in a mechanized and automated manner, such as is explained hereinafter.

Remarkably, each escape orifice 7 is made in a zone of the flexible wall of which it is determined beforehand that it is kept away from the substances contained in the receptacle at the time of their heat treatment.

In the embodiment shown in FIG. 1, the receptacle 1 is made up of an element 2 consisting of a substantially flattened pocket 2, the contour of which is determined by margins, for example a pocket obtained by bending a sheet back on itself, then welding two of its superimposed edges.

In this figure, the pocket 2 has been shown closed, i.e., after parts of its wall 11 which, shown in dotted lines, are held apart to constitute the loading aperture 6, have been brought together and joined, for instance by welding.

When the receptacle consists of a flexible pocket, the contour of which is determined by margins, each escape orifice 7 is made in a zone of the flexible wall which is adjacent to one of its margins.

Indeed, it may be reasonably guaranteed that this zone is kept away from the substances contained in the flexible pocket at the time of their heat treatment.

In another embodiment, shown in FIG. 2, the receptacle 1 is made up of two elements 2, 3, one of which consisting of a tub 3, and the other consisting of a lid 4.

According to the process, one provides oneself with a receptacle made up of two elements 3, 4, of which a tub 3 and a lid 4, and at least one of which has a wall which is at least locally flexible,

The tub 3 including an aperture 6 equipped with a peripheral face 61 intended to co-operate with a lid 4, in turn equipped with a surface 41 bearing on said peripheral face 61 of the aperture 6 of said tub 3, and

the lid 4 including such a surface 41 bearing fluid-tightly on the peripheral face 61 of the loading aperture 6 of the tub 3, and

remarkably:

the lid 4 is placed to bear fluid-tightly on said peripheral face 61 of the aperture of the tub 3,

there is made in at least one of the elements 3, 4 of the receptacle 1 at least one orifice, called escape orifice 7, of a notably reduced cross-section compared with the cross-section of the aperture 6 of said tub 4 [sic] and able to constitute a passage for a gaseous fluid 8 under pressure.

Further remarkably, according to the process of the invention, no later than before the application of the lid 5 [sic] to the tub 4:

at least one of the surfaces 61, 41, which are the peripheral face 61 of the aperture of the tub 4 and/or the bearing surface 41 of the lid 4, with a joint 10 of heat-sensitive material, i.e., a joint 10 comprising a material of a nature such that, at the time of the heat treatment of the contents of the receptacle 1, it produces a fluid-tight connection between the surfaces 41, 61 with which it is placed in contact.

When the receptacle 1 is made up of two elements 3, 4, of which, on the one hand, a tub 3 and, on the other hand, a lid 4, the wall of which is at least locally flexible and comprises a surface bearing on said tub 3, each escape orifice 7 is made in a zone of the lid 4 which is adjacent to its surface bearing on the tub 3.

Indeed, it may be reasonably guaranteed that this zone is kept away from the substances contained in the tub at the time of their heat treatment.

The invention likewise relates to an installation 12 for carrying out the process.

This installation 12 is remarkable in that it comprises:

a first device 13 for making in the wall 11 of the receptacle 1 at least one orifice 7, called escape orifice 7, of a cross-section notably reduced compared with the cross-section of the aperture 6 of said receptacle 1, but which is able to constitute a passage for a gaseous fluid 8 developing its pressure within the receptacle 1.

a second device 14 for heat treatment of the substances 5 by bringing them to the first predetermined temperature value T1, this second device 14 allowing the escape of the gaseous fluid 8 contained in the receptacle 1 through the escape orifice 7 provided for that purpose,

a third device 15 for lowering the temperature of the substances 5 contained in the receptacle 1 down to a third predetermined temperature value T3, and doing so without hindering the possibility for the gaseous fluid 8 contained in the receptacle 1 to escape through the escape orifice 7 provided for that effect,

a fourth device 16 for monitoring at least indirectly the evolution of the temperature of the substances 5 contained in the receptacle 1, for detecting the third temperature value T3, and for producing a control signal 161 when the third predetermined temperature value is, at least, considered to be reached,

a fifth device 17 for stopping the escape orifice 7 made in the wall 11 of said receptacle 1, this device being controlled by the control signal 161 when the third predetermined temperature value T3 is, at least, considered to be reached.

In one embodiment, the first device 13 for making in the wall 11 of the receptacle 1 at least one orifice 7, called escape orifice 7, comprises, on the one hand, a perforating agent 131, such as a punch, and on the other hand, an agent for driving this punch and an automatic control apparatus 132 which exploits at least one item of information relating to the third temperature value T3 and/or to the duration of cooling before stopping.

According to one embodiment, the second device 14 for heat treatment of the substances 5 advantageously consists in a conventional-type steam oven 14.

According to one embodiment, the third device 15 for lowering the temperature of the substances 5 contained in the receptacle 1 down to a third predetermined temperature value T3 consists of a cooling enclosure 15.

As concerns the fourth device 16 for monitoring the evolution of the temperature of the substances 5 contained in the receptacle 1, for detecting the third predetermined temperature value T3, and for producing a control signal 161 when the third predetermined temperature value T3 is, at least, considered to be reached, it may consist of a thermometry apparatus 16 of the type producing a signal, such as an electric signal 6, when a predefined temperature value is detected.

Advantageously, as has been specified above, when a duration of cooling is monitored, this fourth device 16 consists advantageously of a time-measurement device of the type producing a signal, such as an electric signal 161, when the predetermined duration of cooling is reached.

As for the fifth device 17 for stopping the escape orifice 7 made in the wall 11 of said receptacle 1, it advantageously comprises, on the one hand, an applicator agent 171 and, on the other hand, an agent for actuating this applicator agent, as well as an automatic control apparatus 172 which exploits at least one item of information relating to the third temperature value T3 and/or to the duration of cooling before stopping.

The installation 12 is likewise remarkable in that it comprises a sixth device for applying, during cooling and before stopping of the escape orifice 7, a thrust action on the wall 11 of the receptacle 1 so as to cause gradual evacuation of said gaseous fluid 8 and to maintain a certain overpressure within said receptacle 1 in order to carry out at least one of the functions which are:

to affect the shape of this receptacle 1 to an extent which can be compensated for by a rise in the pressure of the gaseous fluid 8 which is produced after stopping of the escape orifice 7,

to accelerate the evacuation of said gaseous fluid 8 until the escape orifice 7 is stopped.

This sixth device advantageously comprises, on the one hand, an agent for applying a thrust and, on the other hand, a driving agent and an apparatus for automatic control of the thrust which exploits at least one item of information relating to the third temperature value T3 and/or to the duration of cooling before stopping.

The installation 12 is further remarkable in that it comprises a seventh device for injecting into the receptacle 1, during cooling, before stopping of the escape orifice 7, a so-called additional gaseous fluid, having predetermined characteristics, and doing so with a flow and pressure such that in escaping through the escape orifice 7, it maintains within the receptacle 1 a pressure of gaseous fluid 8 at a value Pi greater than the value Pe of gaseous pressure outside the receptacle 1 until the moment judged possible for effecting the stopping.

This seventh device advantageously includes a source of pressurized additional fluid, as well as at least one agent for injecting additional gaseous fluid and an apparatus for automatic control of the injection which exploits at least one item of information relating to the third temperature value T3 and/or to the duration of cooling before stopping.

In the drawings, the first predetermined temperature value T1 has been indicated for the contents of said second device 14 for heat treatment of the substances 5.

The third predetermined temperature value T3, for its part, has been indicated for the substances 5 contained in the receptacle 1.

The second predetermined temperature value T2 has been indicated in a circle situated beside each of said second and third devices 14, 15 so as to symbolize, for example, the temperature of the atmosphere situated around these devices 14, 15.

The invention likewise relates to a receptacle 1 designed for carrying out the process.

According to the invention, this receptacle 1 is remarkable in that:

it is made up of at least two elements 3, 4, of which a tub 3 and a lid 4, and at least one of these elements 3, 4 is made of flexible material suitable for being locally perforated by an orifice 7, called escape orifice 7, of a cross-section able to constitute a passage for a gaseous fluid 8 under pressure, the tub 3 including an aperture 6 equipped with a peripheral face 61 intended to co-operate with a lid 4, in turn equipped with a surface 41 bearing on said peripheral face 61 of the aperture 6 of the receptacle 1, the lid 4 including such a surface 41 bearing fluid-tightly on the peripheral face 61 of the loading aperture 6 of the receptacle 1,

it includes a joint 10 which equips at least one of the surfaces 41, 61 which are the peripheral face 61 of the aperture and/or the bearing surface 41 of the lid 4, this joint being made of a material of a nature such that, at the time of the heat treatment of the contents of the receptacle 1, it produces a fluid-tight connection between the surfaces 41, 61 with which it is placed in contact.

By way of non-limiting example, the tub 3 and the lid are made of polypropylene, advantageously of the food type, withstanding a temperature of one hundred twenty degrees Celsius and heating in a so-called microwave oven.

Likewise, the tub 3 and the lid 4 may be made of polyethylene.

According to the invention, this receptacle 1 is remarkable in that it consists of a pocket 2 having a flexible wall 11, made of material suitable for being locally perforated with an orifice 7, called escape orifice 7, of a cross-section able to constitute a passage for a gaseous fluid 8 under pressure.

By way of example, the film materials used in the field of vacuum preservation are suitable for making the pocket 2.

The invention likewise relates to the stopping element 9 for the escape orifice 7.

This stopping element 9 is remarkable in that it consists of a disc 91 of flexible, air-tight material, one 92 of the faces 92, 93 of which is coated with a layer 94 of glue chosen for producing the fluid-tight connection with the wall 11 of the receptacle 1 around at least one orifice 7, called escape orifice 7, so as to hinder the passage of a gaseous fluid 8.

By way of example, the disc 91 is of polypropylene, and one 92 of its faces 92, 93 is coated with a layer 94 of food-type glue.

1. Process for the heat treatment of substances (5) contained in a receptacle (1) having a flexible wall (11), i.e., made up of at least one element (2, 3, 4) having a wall (11) at least locally flexible, and according to which process, for treating the substances (5),
after having placed said substances (5) in the receptacle (1), then closed this receptacle (1), the contents of said receptacle (1) are heated up to a first temperature value (T1), so as to cause the treatment sought,
at the time of cooling of the contents of the receptacle (1) toward a second predetermined temperature value (T2), such as the ambient temperature, before the temperature of the contents of the receptacle (1) reaches this second predetermined temperature value (T2), a gaseous fluid (8) developing a pressure within the receptacle (1) is allowed to escape through at least one orifice (7) of a given cross-section, contrived beforehand in the wall of said receptacle (1), this escape of gaseous fluid (8) taking place until the temperature of the substances (5) contained in this receptacle (1) reaches a third predetermined temperature value (T3), and that at this third predetermined temperature value (T3), the escape orifice (7) is fluid-tightly stopped by means of a stopping element (9),
this process being characterized in that with a view to, simultaneously,
controlling the deformation of the flexible wall of said receptacle (1) at the time of cooling and after the stopping operation and,
guaranteeing the preservation of the substances contained in said receptacle (1), the third temperature value (T3), on the one hand, and the value of the cross-section of the escape orifice (7), on the other hand, are chosen in such a way that this escape orifice (7) can be stopped when:
the temperature (Tg) of the gaseous fluid (8) contained in the receptacle (1) has reached a previously determined value relative to a nominal value considered to be the lower limit for guaranteeing the neutrality of the atmosphere contained in said receptacle (1), and
the value of the pressure (Pi) of this gaseous fluid
(8) within the receptacle (1) is greater than the value of the external gas pressure Pe and reflects the presence within said receptacle (1) of a volume of gaseous fluid (8) at least sufficient so that, after stopping of said escape orifice (7) and cooling of the contents of the receptacle (1) to the second temperature value (T2), said gaseous fluid (8) develops its pressure against the wall (11) of the receptacle (1) and opposes a detrimental deformation of this wall (11) under the influence of the pressure (Pe) outside the receptacle (1), this deformation being considered detrimental when at least one of the visual aspects, which are the visual aspect of the receptacle (1) and that of its contents, is altered.

2. Process according to claim 1, characterized in that, for guaranteeing that at the moment possible for carrying out stopping, the value of the pressure (Pi) of this gaseous fluid (8) is greater than the value (Pe) of the gas pressure outside the receptacle (1), one proceeds in at least one of the five ways which are:
a first way according to which, during cooling, before stopping of the escape orifice (7), evacuation of the gaseous fluid (8) is allowed to take place through the escape orifice
(7) under the combined influence, on the one hand, of the natural production of this gaseous fluid (8) and, on the other hand, of a thrust which is created on this fluid (8) by the wall of the receptacle (1) on which this gaseous fluid (8) has previously impressed an elastic deformation,
a second way according to which, during cooling, before stopping of the escape orifice (7), a thrust action is applied to the wall (11) of the receptacle (1) so as, on the one hand, to cause the gradual evacuation of said gaseous fluid
(8) and to maintain a certain overpressure within said receptacle (1) and, on the other hand, to affect the shape of this receptacle (1) to an extent which can be compensated for by a rise in the pressure of the gaseous fluid (8) which is produced after stopping of the escape orifice (7),
a third way according to which, during cooling, before stopping of the escape orifice (7), a so-called additional gaseous fluid, having predetermined characteristics, is injected into the receptacle (1), and doing so with a flow and a pressure such that, in escaping through the escape orifice (7), it maintains within the receptacle (1) a pressure of gaseous fluid (8) at a value (Pi) greater than the value (Pe) of the gas pressure outside the receptacle (1) until the moment deemed possible for carrying out the stopping,
a fourth way according to which, during cooling, before stopping of the escape orifice (7), a thrust action is applied to the wall (11) of the receptacle (1) in order, while maintaining a certain overpressure within said receptacle (1), to accelerate the evacuation of said gaseous fluid (8) until the escape orifice (7) is stopped,
a fifth way according to which, during cooling, before stopping of the escape orifice (7), a volume of gaseous fluid
(8) is retained within the receptacle (1) at least sufficient so that, after stopping of the escape orifice (7), said gaseous fluid (8) opposes the application of this wall (11) against the substances (5) under the influence of the pressure outside the receptacle (1).

3. Process according to claim 1 or 2, characterized in that:
for choosing the third temperature value (T3), a preliminary heat-treatment test is carried out, and when it is found by this preliminary test that in cooling the receptacle
(1) and its contents to the second temperature value (T2), the substances (5) contained in this receptacle (1) generate a volume of gaseous fluid (8) which, though causing an overpressure within this receptacle (1), does not elastically deform the wall (11) of this receptacle (1) beyond a predetermined acceptable limit,
the third temperature value (T3) is set in such a way that during cooling, the escape orifice (7) is stopped no later than when the temperature (Tg) of the gaseous fluid (8) contained in the receptacle (1) substantially reaches the nominal value.

4. Process according to claim 1 or 2, characterized in that:
for choosing the third temperature value (T3), a preliminary heat-treatment test is carried out, and when it is found by this preliminary test that in cooling the receptacle
(1) and its contents to the second temperature value (T2), the wall (11) of this receptacle (1) has a tendency to lie too closely against the substances (5) at the risk of altering them, and that the presence of a predetermined gas volume would be necessary to oppose the application of the wall (11) against the substances (5) after closing of the escape orifice (7),
the third temperature value (T3) is set in such a way that during cooling, the escape orifice (7) is stopped when the temperature (Tg) of the gaseous fluid (8) reaches a value greater than the nominal value, and doing this so as to retain such a predetermined volume of gaseous fluid (8) within the receptacle (1) so that, after stopping of the escape orifice (7), said gaseous fluid (8) opposes the application of this wall (11) against the substances (5) under the influence of the pressure outside the receptacle (1).

5. Process according to claim 1 or 2, characterized in that, when it is desired to stop the escape orifice (7) when the temperature (Tg) of the gaseous fluid (8) contained in the receptacle reaches a value less than the nominal value, and when at the time of a preliminary heat-treatment test it is found that in cooling the receptacle (1) and its contents to the second temperature value (T2), the substances (5) contained in this receptacle (1) do not generate a sufficient volume of gaseous fluid (8) so that the value of the pressure (Pi) of this gaseous fluid (8) remains notably greater than the value (Pe) of the pressure outside the receptacle (1) at the moment of stopping:
during cooling, a so-called additional gaseous fluid having predetermined characteristics is injected into the receptacle, and this is done with a flow and a pressure such that, in escaping through the escape orifice (7), it maintains within the receptacle (1) a pressure of gaseous fluid (8) at a value (Pi) greater than the value (Pe) of the gas pressure outside the receptacle (1) until the moment deemed possible for carrying out the stopping.

6. Process according to claim 1 or 2, characterized in that:
for choosing the third temperature value (T3), a preliminary heat-treatment test is carried out, and when it is found by this preliminary test that in cooling the receptacle
(1) and its contents to the second temperature value (T2), the substances (5) contained in the receptacle (1) generate a volume of gaseous fluid (8) which becomes capable of affecting the shape of the receptacle (1) essentially only when the temperature (Tg) of said gaseous fluid (8) contained in the receptacle (1) reaches a value notably less than the nominal value,
the third temperature value (T3) is set in such a way that during cooling, the escape orifice (7) is stopped when the temperature (Tg) of the gaseous fluid (8) reaches a value less than the nominal value, and
during cooling, before stopping of the escape orifice
(7), a thrust action is applied to the wall (11) of the receptacle (1) so as, on the one hand, to cause the gradual evacuation of said gaseous fluid (8) and to maintain a certain overpressure within said receptacle (1), and on the other hand, to affect the shape of this receptacle (1) to an extent which can be compensated for by a rise in the pressure of the gaseous fluid (8) which is produced after stopping of the escape orifice (7).

7. Process according to claim 1 or 2, characterized in that, when it is desired to stop the escape orifice (7) when the temperature (Tg) of the gaseous fluid (8) contained in the receptacle reaches a value at least equal to the nominal value, and when, at the time of a preliminary heat-treatment test, it is found that in cooling the receptacle (1) and its contents to the second temperature value (T2), the substances (5) contained in this receptacle (1) generate a volume of gaseous fluid (8) such that the value of the pressure (Pi) of the gaseous fluid (8) becomes notably greater than the value (Pe) of the pressure outside the receptacle (1) and, at least at the moment of stopping, exceeds a predetermined limit value considered unacceptable:
during cooling, a thrust action is applied to the wall
(11) of the receptacle (1) in order, while maintaining a certain overpressure within said receptacle (1), to accelerate the evacuation of said gaseous fluid (8) until the escape orifice (7) is stopped.

8. Process according to any one of the claims 1 to 7, characterized in that the nominal value considered to be the lower limit for guaranteeing the neutrality of the atmosphere contained in said receptacle (1) is 72ø C. (seventy-two degrees Celsius).

9. Process according to claim 2 or 5, characterized in that the so-called additional gaseous fluid, having predetermined characteristics, is made up of bacteriologically neutral air.

10. Process according to claim 2 or 5, characterized in that the so-called additional gaseous fluid, having predetermined characteristics, is made up of a bacteriologically neutral, non-oxidizing gaseous fluid.

11. Process according to claim 2 or 5, characterized in that the so-called additional gaseous fluid, having predetermined characteristics, is made up of a gaseous fluid coming from the receptacle.

12. Process according to any one of the claims 1 to 11, characterized in that, for stopping the escape orifice (7), a stopping element (9) is utilized consisting of a disc (91) of flexible, air-tight material, one of the faces (92, 93) of which is joined fluid-tightly to the surface of the wall (11) which includes the escape orifice (7) so as to close this escape orifice (7) and hinder the passage of fluid through the latter.

13. Process according to any one of the claims 1 to 11, characterized in that a stopping element (9) is utilized consisting of a disc (91) of flexible, air-tight material.

14. Process according to any one of the claims 1 to 11, characterized in that a stopping element (9) is used consisting of a disc (91) of flexible, air-tight material, one (92) of the faces (92, 93) of which is coated with a layer (94) of glue chosen to produce the fluid-tight connection to the wall (11) of the receptacle.

15. Process according to any one of the claims 1 to 14 and according to which one provides oneself with a receptacle (1), the flexible wall (11) of which is made up of two elements (3, 4), of which a tub (3) and a lid (4),
the tub (3) including an aperture (6) equipped with a peripheral face (61) intended to co-operate with a lid (4) in turn equipped with a surface (41) bearing on said peripheral face (61) of the aperture (6) of said tub (3), and
the lid (4) including such a surface (41) bearing fluid-tightly on the peripheral face (61) of the loading aperture (6) of the tub (3), this process being characterized in that:
the lid (4) is placed bearing fluid-tightly against said peripheral face (61) of the aperture (6) of the tub (3),
in at least one of the elements (3, 4) of the receptacle (1), at least one orifice (7) is made, called escape orifice, of a cross-section notably reduced compared with the cross-section of the aperture (6) of said tub (4) [sic] and able to constitute a passage for a gaseous fluid (8) under pressure.

16. Process according to claim 15, characterized in that no later than before the application of the lid (5) [sic] to the tub (4):
at least one of the surfaces (61, 41) which are the peripheral face (61) of the aperture of the tub (4) and/or the bearing surface (41) of the lid (4) is equipped with a joint (10) made of heat-sensitive material, i.e., a joint (10) comprising a material of a nature such that, at the time of the heat treatment of the contents of the receptacle (1), it produces a fluid-tight connection between the surfaces (41, 61) with which it is placed in contact.

17. Process according to any one of the claims 1 to 16, characterized in that each escape orifice (7) is made in a zone of the flexible wall (11) of which it is determined beforehand that it is kept away from the substances contained in the receptacle (1) at the time of their heat treatment.

18. Process according to claim 17, characterized in that when the receptacle (1) consists of a flexible pocket, the contour of which is determined by margins, each escape orifice (7) is made in a zone of the flexible wall which is adjacent to one of said margins.

19. Process according to claim 17, characterized in that when the receptacle (1) is made up of two elements (3, 4) of which, on the one hand, a tub (3) and, on the other hand, a lid (4), the wall of which is at least locally flexible and comprises a surface bearing on said tub (3), each escape orifice (7) is made in a zone of the lid (4) which is adjacemt to its surface bearing on the tub (3).

20. Process according to any one of the claims 1 to 19, characterized in that:
at the time of a test phase in a treatment installation of predefined type, there are determined, on the one hand, said third temperature value (T3) adapted to carry out the stopping of the escape orifice (7) of a receptacle (1) of given type in which certain substances (5) have been placed with a view to their treatment at the first temperature value (T1), and on the other hand, the duration of cooling necessary in order that the temperature of said substances (5) reaches the third temperature value (T3) desired,
at the time of carrying out the process for treating the same substances (5) as those considered during the test, and doing so in a treatment installation similar to the installation used for the test phase, in a receptacle (1) of the same type as that used at the time of this test phase, stopping of the escape orifice (7) is effected when the duration of cooling from the first temperature value (T1) reaches the duration determined during the test phase.

21. Installation for carrying out the process according to any one of the claims 1 to 20, characterized in that it comprises
a first device (13) for making in the wall (11) of the receptacle (1) at least one orifice (7), called escape orifice (7), of a cross-section notably reduced compared with the cross-section of the aperture (6) of said receptacle (1), but which is able to constitute a passage for a gaseous fluid (8) developing its pressure within the receptacle (1),
a second device (14) for heat treatment of the substances (5) by bringing them to the first predetermined temperature value (T1), this second device (14) permitting the escape of the gaseous fluid (8) contained in the receptacle (1) through the escape orifice (7) provided for that purpose,
a third device (5) for lowering the temperature of the substances (5) contained in the receptacle (1) down to a third predetermined temperature value (T3), and doing so without hindering the possibility for the gaseous fluid (8) contained in the receptacle (1) to escape through the escape orifice (7) provided for that purpose,
a fourth device (16) for monitoring the at least indirect evolution of the temperature of the substances (5) contained in the receptacle (1), for detecting the third temperature value (T3), and for producing a control signal (161) when the third predetermined temperature value is, at least, considered to be reached,
a fifth device (17) for stopping the escape orifice
(7) contrived in the wall (11) of said receptacle (1), this device being controlled by the control signal (161) when the third predetermined temperature value (T3) is, at least, considered to be reached.

22. Installation according to claim 21, characterized in that it comprises a sixth device for applying, during cooling and before stopping of of the escape orifice (7), a thrust action to the wall (11) of the receptacle (1) so as to cause the gradual evacuation of said gaseous fluid (8) and to maintain a certain overpressure within said receptacle (1) in order to perform at least one of the functions which are:
to affect the shape of this receptacle (1) to an extent which can be compensated for by a rise in the pressure of the gaseous fluid (8) which is produced after stopping of the escape orifice (7),
to accelerate the evacuation of said gaseous fluid (8) until the escape orifice (7) is stopped.

23. Installation according to claim 21 or 22, characterized in that it comprises a seventh device for injecting into the receptacle (1), during cooling, before stopping of the escape orifice (7), a so-called additional gaseous fluid, having predetermined characteristics, and doing so with a flow and a pressure such that, in escaping through the escape orifice (7), it maintains within the receptacle (1) a pressure of gaseous fluid (8) at a value (Pi) greater than the value (Pe) of the gas pressure outside the receptacle (1) until the moment deemed possible for effecting the stopping.

24. Receptacle designed for carrying out the process according to any one of the claims 1 to 20, characterized in that:
it is made up of at least two elements (3, 4), of which a tub (3) and a lid (4), and at least one of these elements (3, 4) is made of flexible material suitable for being locally perforated with an orifice (7), called escape orifice (7), of a cross-section able to constitute a passage for a gaseous fluid (8) under pressure,
the tub (3) including an aperture (6) equipped with a peripheral face (61) intended to co-operate with a lid (4) in turn equipped with a surface (41) for bearing on said peripheral face (61) of the aperture (6) of the receptacle (1),
the lid (4) including such a surface (41) for fluid-tightly bearing on the peripheral face (61) of the loading aperture (6) of the receptacle (1),
it comprises a joint (10) which equips at least one of the surfaces (41, 61) which are the peripheral face (61) of the aperture and/or the bearing surface (41) of the lid (4), this joint being made of material of a nature such that, at the time of the heat treatment of the contents of the receptacle (1), it produces a fluid-tight connection between the surfaces (41, 61) with which it is placed in contact.

25. Receptacle designed for carrying out the process according to any one of the claims 1 to 20, characterized in that it consists of a pocket (2) having a flexible wall (11), made of material suitable for being locally perforated with an escape orifice (7) of a cross-section able to constitute a passage for a gaseous fluid (8) under pressure.

26. Stopping element designed for carrying out the process according to any one of the claims 1 to 20, characterized in that it consists of a disc (91) of flexible, air-tight material, one (92) of the faces (92, 93) of which is coated with a layer (94) of glue chosen for producing the fluid-tight connection to the wall (11) of the receptacle (1) around at least one escape orifice (7) so as to hinder the passage of a gaseous fluid (8).

27. Substances treated according to the process which is the subject of any one of the claims 1 to 20 and being placed in flexible-walled receptacles according to one of the claims 24 or 25, these receptacles being equipped with a stopping element according to claim 26.
